(19) United States
(12) Patent Application Publication
(10) Pub. No.: US 2013/0130889 A1
(43) Pub. Date: May 23, 2013

(54) PROCESS FOR MAXIMUM DISTILLATE PRODUCTION FROM FLUID CATALYTIC CRACKING UNITS (FCCU)

(71) Applicants: Eusebius Gbordzoe, Houston, TX (US); Marc Bories, Saint Jouin de Bruneval (FR); Warren Stewart Letzsch, Ellicott City, MD (US); Patrick Leroy, Saint Vigor d'Ymonville (FR); Chris Santner, Houston, TX (US); Joseph L. Ross, JR., Princeton, NJ (US)

(72) Inventors: Eusebius Gbordzoe, Houston, TX (US); Marc Bories, Saint Jouin de Bruneval (FR); Warren Stewart Letzsch, Ellicott City, MD (US); Patrick Leroy, Saint Vigor d'Ymonville (FR); Chris Santner, Houston, TX (US); Joseph L. Ross, JR., Princeton, NJ (US)

(73) Assignee: Stone & Webster Process Technology, Inc., Houston, TX (US)

(21) Appl. No.: 13/298,636

(22) Filed: Nov. 17, 2011

(51) Int. Cl. B01J 29/40; B01J 19/00; B01J 29/04; C10G 1/00; B01J 21/08; B01J 21/12; B01J 23/02; B01J 23/00; C10G 63/08; B01J 29/08

(52) U.S. Cl. 502/77; 208/78; 422/619; 502/60; 502/79; 502/232; 502/263; 502/340; 502/349; 502/355; 585/240

(57) ABSTRACT

The present invention provides an improved fluidized catalytic cracking process coupled with a two stage regeneration process in which the activity of the circulating catalyst is independently controlled for cracking hydrocarbon feedstocks or the vapors at low severity to produce maximum light cycle oil/distillate in one riser whilst cracking recycle streams comprising heavy cycle oil (HCO), light cracked naphtha (LCN) etc. in a second riser operating at high severity to produce LPG.

### BACKGROUND OF THE INVENTION

I. Field of the Invention

The present invention relates to a reactor for increasing or maximizing middle distillate production from hydrocarbon feedstocks. More specifically, the present invention is directed to a unique process and reactor system that increases or maximizes middle distillate, e.g. light cycle oil, production from hydrocarbon feedstocks.

II. Background of the Related Art

It is common commercial practice to produce gasoline, heating oil and diesel fuel by cracking heavier petroleum fractions. One of the major commercial techniques for accomplishing this conversion is fluid catalytic cracking (FCC). In FCC, a feed petroleum fraction such as vacuum gas oil, heavy atmospheric gas oil, etc., is contacted with particles of hot, active catalyst at high temperatures and low pressures of about 1 to 5 atmospheres absolute in the absence of added hydrogen. The catalyst should be in sufficient quantity and at a sufficient temperature to vaporize the oil feed, raise the oil feed to a cracking temperature of about 900 to 1100° F. and supply the endothermic heat of reaction. The oil and catalyst flow together (concurrently) for a time sufficient to carry out the intended conversion. During the conversion of the heavy petroleum fraction to lighter fractions, coke is laid down on the catalyst particles thereby deactivating them. These deactivated catalyst particles are separated from the cracked petroleum product, stripped of volatile hydrocarbons and transported to a separate regenerator. In the regenerator the coked catalyst is combined with an oxygen containing gas, e.g., air, whereby coke is burned off the catalyst and the catalyst is both reactivated and heated. The heated, reactivated catalyst is then returned into admixture with further heavy oil feed, thus completing the cycle. Typical FCC processes are described in greater detail in U.S. Pat. Nos. 4,064,039; 4,344,926; 4,194,965; 3,963,603; 4,428,822; and 3,879,281, incorporated herein by reference in their entirety.

A particularly successful approach, which significantly diminishes the problems associated with severe operating conditions including high temperatures, is described, for example, in U.S. Pat. Nos. 4,664,778; 4,601,814, 4,336,160; 4,332,674 and 4,331,533. In such processes, a combination of high temperature fluidized catalytic cracking-regeneration operation is provided for the simultaneous conversion of both of the high and low boiling components contained in gas oils and residual oils with high selectivity to gasoline and lighter components, and with low coke production. These high temperature conversion processes have been made possible in part due to the use of two-stage catalyst regeneration processes. In the first stage of such regeneration processes, catalyst particles, which have hydrocarbonaceous materials such as coke deposited on them, are regenerated under conditions of oxygen concentration and temperature selected to particularly burn hydrogen associated with hydrocarbonaceous material. These conditions result in a residual level of carbon left on the catalyst and the production of a carbon monoxide (CO)-rich flue gas. This relatively mild first regeneration serves to limit local catalyst hot spots in the presence of steam formed during hydrogen combustion so that the formed steam will not substantially reduce the catalyst activity. A partially regenerated catalyst substantially free of hydrogen in the remaining coke and comprising residual carbon is thus recovered from the first regenerator stage and passed to a second stage higher temperature regenerator where the remaining carbon is substantially completely burned to CO₂ at an elevated temperature up to 1500° F. This second stage regeneration is conducted under conditions and in the presence of sufficient oxygen to burn substantially all residual carbon deposits and to produce CO₂-rich fluid gas.

The regenerated catalyst is withdrawn from the second stage and charged to the riser reactor at a desired elevated temperature and in an amount sufficient to result in substantially complete vaporization of the hydrocarbon feed. The catalyst particles are typically at a temperature above 1300° F. and often above 1400° F., such that at the selected catalyst feed rate and hydrocarbon feed rate the vaporizable components of the hydrocarbon feed are substantially completely vaporized rapidly in the riser reactor whereby subsequent catalytic cracking of the feed is accomplished.

A schematic of an FCC unit employing this technology is shown in FIG. 1. The unit consists of one riser reactor, a packed stripper and a multi-stage regenerator. The shown regenerator is a two-stage regenerator where the spent catalyst particles are passed, successively, to first and second (relatively lower and higher temperature) catalyst regeneration zones. Once the catalyst completes its cycle through the regenerator as described herein above, the fully regenerated catalyst is withdrawn from the second stage regenerator and charged to the riser reactor at a desired elevated temperature and in an amount sufficient to result in substantially complete vaporization of the hydrocarbon feed. The vaporized hydrocarbon feed upon contact with hot fully regenerated catalyst undergoes a catalytic cracking, while proceeding upward in the riser reactor. Once both vaporized catalytically cracked hydrocarbon products and the spent catalyst reach the stripper vessel, the spent catalyst is removed from the cracked products, directed to a stripper zone for removal of volatiles and then directed to the bottom section of the regenerator, thereby completing the FCC unit cycle.

As will be appreciated by those skilled in the art, while gasoline is usually the most valuable product of the FCC unit, other products can seasonally increase in value to the point where it is advantageous to increase their yields. For example, in winter the value of light cycle oil (LCO), when used as a blending component in heating oil, can be greater than that of gasoline. As will be appreciated by those skilled in the art, the above-described FCC processes have the potential capability for increasing selected product yields, for example, gasoline or light cycle oils (LCO)/distillate, from a given hydrocarbon feedstock. As an FCC unit operation is shifted from a gasoline producing mode, for example, into a maximum distillate producing mode or operation, the LCO yield and cetane quality thereof improves and, thus, can be used more favorably for blending to form, for example, a diesel fuel product. In another embodiment, such processes also have the potential capability of producing large yields of olefins, especially propylene and butylenes, for use as valuable alkylation gasoline charge stock, or in the manufacture of petrochemicals. Under such circumstances, it is therefore often desirable to operate the FCC processes in such a manner so as to increase or maximize the production of a given product or products depending on the demand.

One approach of increasing LCO yield is to reduce the FCC unit cracking severity so that conversion declines. At the lower conversion, yields of heavy products (light cycle oil, heavy cycle oil, and clarified oil) will increase while yields of light products (gasoline, LPG, and gas) and coke will decrease. The cracking severity can be reduced in several ways such as reducing catalyst activity, lowering riser reactor temperature, gas residence time, reducing the catalyst/oil ratio by increasing feed preheat temperature. In particular, it is known that LCO distillate yields can be increased by restricting riser outlet cracking temperature to within the range of about 870° F. to about 970° F., and more particularly with the range of about 900° F. to about 950° F. Alternatively, it is also known that the conversion can be controlled in FCC processes by the amount of hot regenerated catalyst cycled through the riser reactor in a given amount of time, e.g. catalyst-to-oil ratio. Thus, LCO/distillate and other fuel products production is maximized as conversion of the hydrocarbon feedstock to gaseous product yield including C₃/C₄ olefins and lower boiling range material is decreased.

However, decreasing the catalyst-to-oil ratio or restricting the riser cracking outlet temperature in order to maximize LCO/distillate production is accompanied by several disadvantages. First, a lower catalyst-to-oil ratio decreases the rate of catalytic activity. Moreover, as the riser outlet temperature is decreased, the temperature in the riser feed zone or mixed zone also decreases, which might impair the feed vaporization, especially in the case of heavy feed processing. It is well known by those skilled in the art that Mixed Temperature Control (MTC) technology will help vaporize the feed by artificially increasing the riser mixed zone temperature in the feed zone without necessarily increasing the riser outlet temperature.

In another approach, a catalyst may be substituted that would allow the refiner to maintain the cracking severity as high as possible while maximizing LCO yield. Catalysts which contain an active matrix provide more cracking sites for the large hydrocarbon molecules typically found in heavy cycle oil and clarified oil. This greater matrix cracking activity, which is usually associated with high alumina content and a high surface area, allows such catalysts to upgrade bottoms to light cycle oil. While the catalytic route to maximizing LCO yield may be attractive, to change a catalyst in a commercial FCC unit can take several weeks or months to complete and makes this approach unpractical when LCO demand changes suddenly.

In yet another approach, the FCC unit feed may be fractionated to remove light ends in the LCO boiling range before subjecting the feed to the cracking process. The feed fractionation method of increasing light cycle oil, however, is prohibitively expensive if existing equipment cannot be used.

In view of the above, it is therefore an object of the present invention to provide a high temperature fluidized catalytic cracking-regeneration process wherein the production of a desired product or products from catalytic cracking of gas oils or residual oils or mixtures thereof and the like is maximized. More particularly, it is an object of this invention to provide such processes with flexibility to produce more distillates through manipulation of catalyst activity by using partially regenerated catalyst, cat-oil ratios, lower riser outlet temperature and the use of riser MTC to enhance feed vaporization.

It is a further object of the present invention to provide such processes as described above wherein the catalytic cracking process is carried out successively in separate riser reactors each independently operating under selected conditions.

Additional objects of the present invention will become apparent from the following summary and detailed discussion of preferred embodiments of this invention.

### SUMMARY OF THE INVENTION

In accordance with the present invention, an improved fluidized catalytic cracking-regeneration process is provided wherein the desired product, such as middle distillate, is increased or maximized by selectively restricting the respective riser catalytic cracking activity to optimal or more preferable ranges by controlling the input of catalyst with desired micro-activity defined by the micro activity test (MAT) according to ASTM D-3907 and temperature from the multi-stage regenerator to achieve a desired rate of conversion of the feedstock. To this end, the desired selective catalytic cracking reactions can be accomplished by separately adjusting cracking conditions in separately maintained riser reactors, wherein the catalyst within each riser reactor is provided by a shared multi-stage regenerator.

Accordingly, the present invention provides a method for maximizing middle distillate production and quality from a hydrocarbon feed, said method comprises:

a) delivering a partially-regenerated catalyst to a first riser reactor and a fully-regenerated catalyst to a second riser reactor and optionally to said first reactor;

b) cracking the first feed chosen between a hydrocarbon feed and a recycle feed comprising at least uncracked bottoms in the first riser reactor to produce a first cracked product and spent catalyst;

c) separating said first cracked product including a middle distillate from said spent catalyst in a single reactor vessel;

d) recovering said first cracked product including said middle distillate and separating uncracked bottoms from said first cracked product;

e) cracking the second feed chosen between the recycle feed or the hydrocarbon feed, but different from the first feed, in the second riser reactor to produce a second cracked product;

f) separating the second cracked product including a middle distillate from spent catalyst in said single reactor vessel; and

g) passing the spent catalyst from the first and second riser reactors to a multi-stage catalyst regenerator unit,

wherein said multi-stage catalyst regeneration unit provides said partially-regenerated catalyst and said fully-regenerated catalyst having different MAT activity for use in said first and/or said second riser reactors.

The multi-stage catalyst regenerator unit of the method comprises a single two-stage catalyst regenerator unit and the spent catalyst is partially regenerated in a first regeneration stage of said two-stage catalyst regenerator, a first portion of said partially-regenerated catalyst is delivered to the first riser reactor; a second portion of said partially-regenerated catalyst is delivered to a second regeneration stage of said two-stage catalyst regenerator, to produce fully regenerated catalyst, and said fully-regenerated catalyst is delivered to said second riser reactor and, optionally, to said first riser reactor.

Further, the present invention is directed to a hydrocarbon cracking system for maximizing middle distillate production and quality from a hydrocarbon feed comprising, a multistage-stage catalyst regeneration unit that provides partially-regenerated catalyst and/or fully-regenerated catalyst, respectively, to a first riser reactor and a second riser reactor, each receiving a different feed chosen between hydrocarbon feed and recycle feed, and a single reactor vessel to send coked catalyst to said regeneration unit, wherein the catalyst of said system has a different MAT activity in said partially-regenerated catalyst and said fully regenerated catalyst.

The system's multi-stage catalyst regenerator unit comprises a single two-stage catalyst regeneration unit having a first regeneration stage and a second regeneration stage and wherein the catalyst is a partially-regenerated catalyst at the exit of the first regeneration stage and a fully-regenerated catalyst at the exit of the second regeneration stage.

One advantage of the present invention is that it is possible to operate the FCCU with the same catalyst with different catalyst MAT activities that is, partially regenerated catalyst in the feed to a first riser reactor (R1) and fully regenerated catalyst is feed to a second riser reactor (R2), wherein the second riser reactor can be considered a recycle riser. As a result, the bottom products obtained from riser reactor (R1) at the low MAT activity, will be easy to crack in the riser reactor (R2) using a higher MAT catalyst and at higher severity, i.e., operating conditions such as higher riser outlet temperature.

This FCCU configuration takes advantage of the flexibility offered by any multi-stage regenerator configuration, e.g., two-stage regenerator, where the carbon on regenerated catalyst (CRC) from the first regenerator (RGN1) in partial burn conditions can be manipulated by adjusting the operating conditions, such as, combustion air flowrate. For a given catalyst type characterized by unit cell size, FIG. 4 shows how the MAT activity will change for each 0.1 wt % change in the CRC. Another method for controlling the CRC and the temperature of the catalyst in the first regenerator (RGN1) is to recycle hot fully regenerated catalyst from the second regenerator (RGN2) to RGN1 in order to add, at the desired proportion, hot regenerated catalyst to decrease the average CRC on the catalyst and increase RGN1 temperature. Further in this regard, a catalyst cooler can be installed in the recycle line from RGN2 to RGN1 to provide operational flexibility for decoupling the control of the average CRC and the average temperature of the catalyst in RGN1. Another option is to install the catalyst cooler either on RGN1 or RGN2 vessel.

An object of the present invention is to operate the FCCU in a conversion region that maximizes LCO production and cetane index while minimizing slurry yield.

The process of the present invention will be better understood by reference to the following detailed discussion of preferred embodiments and the attached FIGURES which illustrate and exemplify such embodiments. It is to be understood, however, that such illustrated embodiments are not intended to restrict the present invention since many more modifications may be made within the scope of the claims without departing from the spirit thereof.

### BRIEF DESCRIPTION OF THE DRAWINGS

Various embodiments of the overall invention are shown by way of example in the attached Figures, wherein:

FIG. 1 is a schematic representation of a fluid catalytic cracking apparatus of prior art with one riser reactor (adapted from Gauthier et al., 2000, FCC: Fluidization phenomena and technologies. Oil & Gas Science and Technology—Rev. IFP 55 (2), 187-207; incorporated herein by reference).

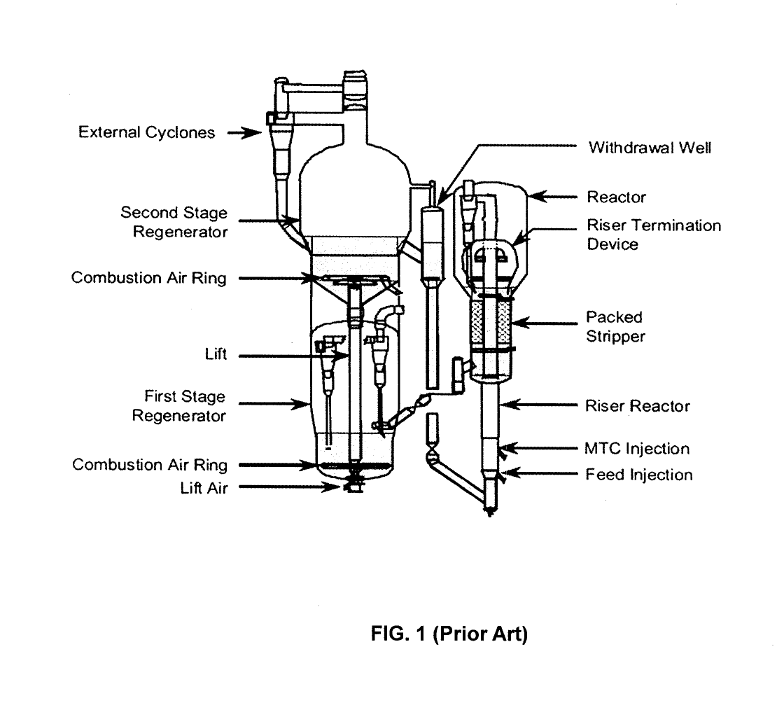

FIG. 2 is a graph illustrating the effect of conversion on liquids yield in the pilot plant of the present invention. It also shows that maximizing LCO tends to increase slurry oil yield. Standard conversion is defined as the wt % of fresh feed converted to coke and products with boiling range ≦430° F. Thus, as less of the feedstock is converted, the amount of LCO and slurry oil will increase. Importantly, the valuable slurry oil is minimized and the more valuable LCO is maximized.

FIG. 3 is a schematic representation of a fluid catalytic cracking apparatus of the present invention, wherein the two-stage regenerator contains a recycle line and catalyst cooler to supply fully-regenerated catalyst to the first regeneration stage and either fully or partially regenerated catalyst to the two riser reactors to maximize the production of the middle distillate.

FIG. 4 is a graph illustrating the effect of carbon on regenerated catalyst (CRC) on the catalyst Micro Activity Test (MAT) as a function of catalyst unit size.

FIG. 5 is a graph illustrating the conversion of the fresh feed to coke and products with ≦430° F. boiling point. The lower the CRC, the higher the conversion of the feedstock because the catalyst is more active. Maximum LCO production requires less active catalyst and less severity of operation, such as, lower riser outlet temperature.

FIG. 6A is a flow diagram showing a modified process of FIG. 3, where the solid lines indicate the hydrocarbon streams and the dashed lines indicate the catalyst streams, and riser reactor R1 receives a partially regenerated catalyst of regenerator RGN1 and riser reactor R2 receives a fully regenerated catalyst of regenerator RGN1. If required, the partially regenerated catalyst from regenerator RGN1 can be mixed with some fully regenerated catalyst from regenerator RGN2 prior to entering riser reactor R1

FIG. 6B is a flow diagram showing a process for maximizing middle distillate described in FIG. 3, where the solid lines indicate the hydrocarbon streams and the dashed lines indicate the catalyst streams. Riser reactor R1 receives a partially regenerated catalyst of regenerator RGN1 and a riser reactor R2 receives a fully regenerated catalyst of regenerator RGN2.

FIG. 6C is a flow diagram showing another alternative of the process of FIG. 3, operating in a single riser mode with high severity where the feed riser reactor R2 is turned off and the fresh feed riser reactor R1 receives a fully regenerated catalyst of regenerator RGN2. The embodiment presented in FIG. 6C displays the invention's flexibility for converting from maxi-LCO mode of operation to maxi-gasoline mode.

### DETAILED DESCRIPTION OF THE INVENTION

In accordance with the present invention, an improved hydrocarbon cracking system for maximizing middle distillate production is provided, the system comprising, a single multistage-stage catalyst regeneration unit that provides partially-regenerated catalyst and/or fully-regenerated catalyst to a first riser reactor for receiving a hydrocarbon feed and a second riser reactor for receiving a recycled feed. The partially-regenerated catalyst and the fully-regenerated catalyst have a different MAT activity, due to different CRC levels.

The invention contemplates a catalytic cracking process designed to maximize middle distillate production from hydrocarbon feedstocks. In the following text, middle distillate will be referred as light cycle oil (LCO), which is a hydrocarbon cut having a boiling range from about 302° F. to about 716° F. As best understood by one skilled in the art, this boiling range may vary to some extent from one refinery to another depending on, for example, the blending requirements to provide finished products having properties that meet local mandatory regulations. The feedstocks can be either vacuum gas oils, heavy atmospheric gas oil, atmospheric resid, vacuum resid, coker gas oils, visbreaker gas oils, deasphalted oils, hydrocracker bottoms and any hydrocarbon feed stream from an extraction process or any combination of the above streams or hydrotreated counter parts. The feed could also present some components coming from biomass like vegetable oils or biomass to oil products obtained by various processes.

For the purpose of this invention, the above-stated hydrocarbon feedstocks will be referred to as fresh hydrocarbon feed or fresh feed. Similarly, for the purpose of this invention, the designation “recycle” or “recycle feed” refers to the hydrocarbon stream that has already underwent some hydrocarbon cracking, for instance, in the fresh feed riser reactor, however, it may also be envisioned that the feed may come from a separate FCC unit. It will be appreciated by those skilled in the art that the product(s) of the initial cracking process may need to undergo additional processing, such as distillation, to isolate the products that require further cracking in the recycle feed reactor riser. Such additional isolation/distillation processes are well known to those of ordinary skill in the art.

The catalyst used in the process preferably will have limited activity since the objective is to make middle distillate rather than gasoline. The catalyst will minimize hydrogen transfer reactions since these convert naphthenes into aromatics and reduce distillate yield and cetane number of the distillate. The catalyst is preferably comprised of a large pore zeolite and an active matrix that contains ingredients to crack heavy oil mainly into LCO (diesel boiling range) and gasoline. The large pore zeolite content in the fresh catalyst may be limited to less than 10 wt % of the catalyst, considerably less than that found in most gasoline oriented fluid cracking catalysts. The catalyst may preferably have relatively weak acid sites on the matrix. The carbon on the partially regenerated catalyst may also likely poison the strongest acid sites further enhancing LCO production in the feed riser.

It will appreciated and understood by those skilled in the art that the present invention significantly increases or maximizes the production of middle distillate using an FCC system containing, inter alia, at least two riser reactors and a multi-stage catalyst regeneration unit, which is capable of providing regenerated catalyst having different catalytic activity (i.e., MAT activity). The inventive efficiency is accomplished by supplying partially-regenerated catalyst to the hydrocarbon feedstock in one riser reactor (i.e., the “fresh” riser reactor R1) and supplying fully-regenerated catalyst to a second riser reactor R2 containing a “recycle” feed. The recycle feed will contain mostly low value products, such as slurry oil, obtained from the fresh feed riser reactor using catalyst having low catalyst MAT activity. The recycle feed is cracked in a second reactor riser (i.e., the “recycle riser reactor” or R2) with a catalyst having a higher catalyst MAT activity and cracking severity due to a higher temperature and catalyst-to-oil ratio. One will notice that depending on the economics, naphtha cut stocks may also be recycled in the recycle riser reactor in order to promote LPG production.

MAT stands for microactivity and represents the feedstock cracking potential of a given catalyst. In the FCC process, the catalyst circulating in the unit undergoes some aging due to combined effect of steam, high temperature and metals that leads to zeolite destruction responsible for catalyst activity reduction. In order to adapt the catalyst addition rate, it is necessary to sample equilibrium catalyst from the unit and assess its activity through a microactivity test. This test is generally performed in a fixed bed micro reactor using a standard feedstock and operating conditions, such as, riser outlet temperature (ROT) and catalyst-to-oil ratio (C/O). From this test, MAT expressed in weight percent (wt %) is defined as the conversion of the feedstock to products with boiling point ≦430° F. Some other factors can also be determined from this test, known by those skilled in the art, such as, coke and gas factors, to better appreciate the cracking potential and behavior of equilibrium catalysts. One will notice that using standard test under standard operating conditions allows a relative comparison between tested catalysts. For typical FCC equilibrium catalysts the catalyst MAT ranges from 50 to 80 wt % and, more generally, from 62 to 77 wt %. For FCC units operating under maxi—gasoline mode (i.e., maximum gas mode), catalyst MAT is usually higher than 70 wt %.

Products obtained from cracking such feedstocks include, but are not limited to, gaseous product streams comprising C₂ through C₆ light olefins, C₆-C₈ light FCC gasoline, intermediate FCC gasoline comprising benzene and C₈-C₉ hydrocarbons, heavy FCC gasoline comprising C₉ -C₁₁ hydrocarbons and other gasoline boiling range products comprising materials boiling in the range C₅ (about 100° F.) to about 430° F., light cycle oil/distillate boiling in the range from about 430° F. to about 650° F., a heavy cycle oil product boiling from about 650° F. to about 900° F., and a slurry oil boiling from about 970° F. and above. Some units do not have a heavy cycle draw and their slurry oil is the 650° F. plus material. As previously stated, according to one embodiment of the invention, the process allows increased production of middle distillate, referred in text as light cycle oil, which is a hydrocarbon cut with a boiling range going from 302° F. to 716° F. and preferably from 430° F. to 580° F.

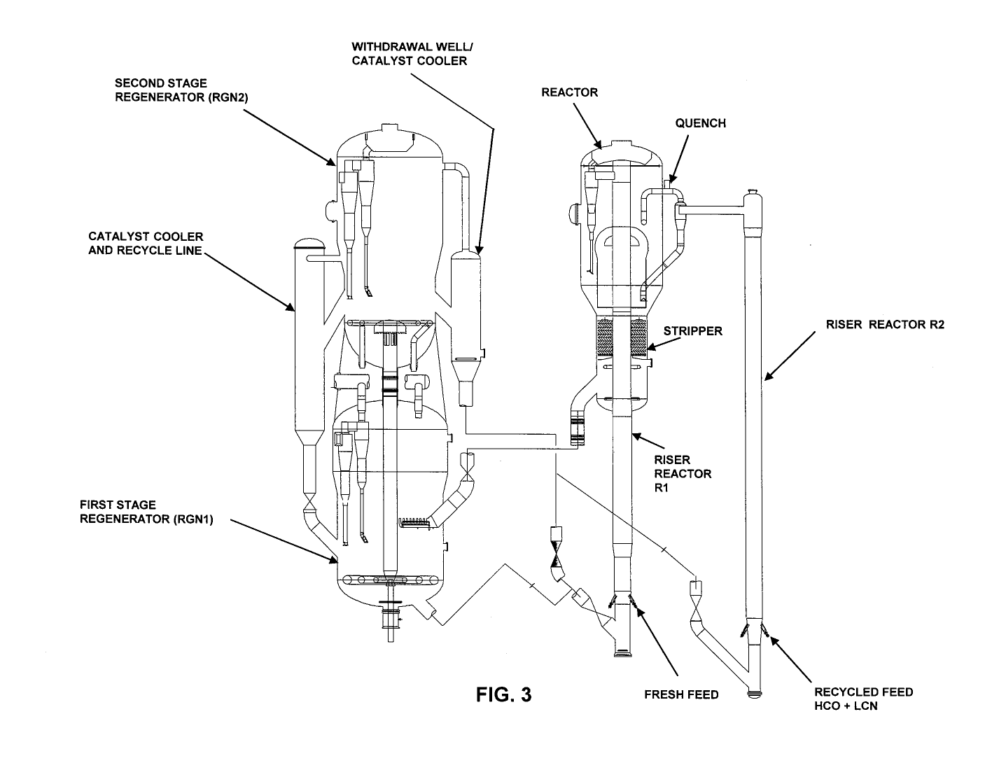

A schematic of an FCC unit of one embodiment of the present invention is shown in FIG. 3. The unit consists of a two riser reactor system, herein termed fresh feed riser reactor R1 and recycle feed riser reactor R2, a reactor/stripper vessel, catalyst/vapor separating devices, and a multi-stage regenerator. It is preferred in the process of the present invention that the regenerator is a multi or two-stage regenerator type, wherein the spent catalyst particles are passed, successively, to first and second (relatively lower and higher temperature) catalyst regeneration zones/stage (regenerator RGN1 and regenerator RGN2) in the manner of the process described, for example, in U.S. Pat. Nos. 4,664,778; 4,601,814; 4,336,160; 4,332,674; and 4,331,533, which are incorporated herein by reference.

In accordance with this invention, the first regenerator stage regenerator RGN1 acts as a mild pre-combustion zone that partially removes the coke, e.g., from about 40 to about 70%, on the catalyst, thereby restoring some catalytic activity (partially regenerating) of the FCC catalyst.

According to one embodiment of the invention, in order to increase or maximize light cycle oil/distillate production, the catalyst used in treating the hydrocarbons in the fresh feed riser reactor preferably must have limited MAT activity, generally, from about 30 to about 65 wt %, and more particularly, the MAT activity is below about 56 wt % and preferably below about 62 wt %, which can be controlled by means of regulating/adjusting carbon (coke) remaining on the regenerated catalyst by manipulating the operation of regenerator RGN1.

More active, fully regenerated catalyst from regenerator RGN2 is delivered to the second or recycle riser reactor, i.e., riser reactor R2, to optimally convert recycle feedstocks with reaction conditions independent of the main riser reactor. The MAT activity of catalyst to riser reactor R2 is, generally, from about 50 to about 80 wt %.

In another embodiment of the invention, as will be appreciated by those skilled in the art, the maximization of light cycle oil/distillate production in addition to controlling the catalyst activity in the riser reactor can also be achieved/supplemented by regulating catalyst-oil ratio and/or the outlet temperature in the riser reactor.

As shown in FIG. 3, the partially-regenerated catalyst with a desired limited activity and temperature from regenerator RGN1 flows directly to the bottom of the riser reactor termed fresh feed of riser reactor R1. After a short reacceleration zone to stabilize the catalyst flow, preheated finely atomized oil feed is injected into the fresh feed of riser reactor R1 for contact with the partially-regenerated catalyst. Preferably, the oil feed is injected using atomizing spray nozzles as known in the art, or a high energy injection system sufficient to effect a rapid and substantially complete vaporization of the feed. To increase light cycle oil/distillate production in one embodiment of the invention, the riser reactor R1 temperature of the fresh feed-catalyst mixture varies from about 832° F. to about 1155° F., and preferably from about 900° F. to about 950° F. As will be appreciated by those skilled in the art, the lower temperature of hydrocarbon-catalyst mixture has the effect of reducing the rate of catalytic conversion of the hydrocarbon feed into gasoline and C₃-C₆ olefinic products thereby enhancing the production of light cycle oil/distillate, and to a lesser extent materials heavier than light cycle oil. These heavier materials may then be sequentially recycled for cracking in the recycle feed riser reactor R2 over hot fully-regenerated catalyst from the second stage Regenerator RGN2 with cracking temperature ranging from about 970° F. to about 1205° F., and preferably in the range from about 990° F. to about 1150° F. range.

For a given feed and preheat temperature, catalyst circulation will adjust in both risers to match with the heat balance of the unit. Since severity is very different from riser reactor R1 to riser reactor R2, it is therefore expected the catalyst to oil weight ratio (C/O) to be also very different from one riser to the other. In riser reactor R1, since cracking temperature is low, C/O will vary from about 4 to about 10, and preferably from about 4.5 to about 6, while in Riser reactor R2 at higher cracking temperature, C/O will vary from about 8 to about 20, and preferably from about 10 to about 15.

At the end of the fresh feed riser reactor R1, a riser termination device may optionally be installed to rapidly separate hydrocarbon vapors and catalyst particles to reduce further thermal and catalytic cracking. Such a device is usually recommended for high severity operation, which is not the case in the present invention, unless the FCCU is no longer run in “distillate mode” but back in “gasoline mode” for economic reasons. Although the riser termination device may be located external to a stripper vessel, in a preferred embodiment as depicted in FIG. 3, the riser termination device is located internal to and in an upper dilute portion of the reactor vessel. An external rough cut cyclone separating device is installed atop of riser reactor R2 for separation of the catalyst from the vapor products. The separated catalyst flows into the stripper via diplegs. The vapors are quenched with a hydrocarbon stream such as HCO to the vapor temperature of riser reactor R1 to minimize product degradation from thermal cracking. The vapor streams from the exit of the first riser reactor R1 separation device is combined with the vapor stream from the second riser reactor R2 and sent to the reactor cyclones to further remove entrained catalyst fines prior to entering the main fractionator (not shown). The stripper reactor vessel also includes a lower dense phase section which acts as a stripper, wherein steam is used to remove most of the volatile entrained hydrocarbon vapors in a counter-current fashion, preferably with packing and multiple steam injections. In the upper dilute phase, the separated cracked products (which optionally may be quenched) are directed from the riser termination device into cyclones for further separation of entrained catalyst particles. The cyclones can be open to the upper dilute phase or close coupled to the riser termination device. The hydrocarbon vapor products leaving the separator cyclones are then separated in a downstream main fractionation column into separate product fractions. As the cracking reactions proceed throughout both risers, heavy hydrocarbons are cracked into gaseous products moving upwards with the catalyst in the riser, and coke, typically 4-8 weight percent of the feed, deposits on the catalyst, thereby, substantially reducing its activity. The stripped spent catalyst from the stripping zone of the stripper vessel is directed to the top of the first stage Regenerator RGN1 fluidized bed.

In the fluidized bed of regenerator RGN1, catalyst activity is restored by combustion of coke entrained/deposited on the catalyst in a strictly controlled air flow to a desired level. In such processes, the stripped spent catalyst is passed to a first dense fluid bed of catalyst in regenerator RGN1 maintained under oxygen and temperature restricted conditions below about 1500° F., and preferably not above about 1300° F. Combustion of hydrocarbonaceous material or coke deposited on the spent catalyst in regenerator RGN1 is conducted at relatively mild temperatures sufficient to burn substantially all the entrained hydrocarbon vapors present in the coke deposits and a portion of the carbon coke deposited on the catalyst. The regeneration temperature is thus most preferably restricted to within the range of from about 1150° F. to about 1305° F. and preferably to a temperature which does not exceed the hydrothermal stability of the catalyst or the metallurgical limits of a conventional low temperature regeneration operation that ranges from about 1400° F. to about 1450° F. Flue gases relatively rich in carbon monoxide are recovered from the first regeneration zone and can be passed, for example, through a power recovery prime mover section to generate either electricity or drive the air blowers prior to joining the flue as from regenerator RGN2. The combined flue gas is sent to a carbon monoxide boiler or incinerator to generate steam by promoting a more complete combustion of available carbon monoxide.

Besides restoring the catalyst activity, the combustion process in regenerator RGN1 also raises the catalyst temperature, thus providing the necessary energy to the vaporization of the feed and the cracking reactions in the riser. It will be appreciated and understood by those skilled in the art, that it is essentially possible to regulate the combustion process by adjusting the air flow rate, hence, regulate the amount of carbon on regenerated catalyst (CRC) and its temperature to the level that would increase or maximize the distillate production in the fresh feed riser. For this purpose, the CRC target should be between about 0.2 to about 0.8 weight percent, and preferably between about 0.30 to about 0.6 weight percent to achieve the desired catalyst deactivation to produce distillate in the riser reactor R1. The partially regenerated catalyst from regenerator RGN1 that is not used in the fresh feed riser reactor, as shown in FIG. 3, is air-lifted to the elevated second Regenerator RGN2, where the remaining coke deposits are substantially completely burned to carbon dioxide at an elevated catalyst temperature within the range of from about 1300° F. up to about 1800° F. and preferably within the range of from about 1300 to 1400° F., in an essentially moisture free environment in order to minimize catalyst deactivation. The second regeneration zone is designed to limit catalyst inventory and catalyst residence time therein at the high temperatures while promoting a carbon burning rate to achieve a residual carbon on regenerated catalyst (CRC) to less than about 0.1 weight percent.

After processing in regenerator RGN2, the fully regenerated catalyst flows through the standpipe to the bottom of the riser reactor R2, termed recycle feed riser. A preheated finely atomized oil recycle feed, which may comprise, for example, the bottom products obtained from the fresh feed riser reactor R1, is injected onto the hot fully-regenerated catalyst from regenerator RGN2 in the recycle feed riser, i.e., riser reactor R2. According to an embodiment of the invention, upon contacting the catalyst in the riser reactor, the feed vaporizes to form a highly vaporized contact phase of the hydrocarbon feed with dispersed high temperature fluid catalyst particles. The operating conditions within the recycle riser reactor R2 are set such that conversion of the recycle feed is maximized. Thus, reactor temperature will be in the range from about 950° F. to about 1200° F., with a C/O being in the range from about 7 to about 20 weight/weight, preferably from about 10 to about 15 weight/weight. Operating conditions and feed quality sent to this recycle riser may be set in different ways to satisfy changing economics.

For both risers (i.e., riser reactors R1, and R2), the hydrocarbon feeds can also be contacted with the fluid cracking catalyst particles at an elevated temperature in the presence of one or more diluents such as steam in the riser contact zone. Such diluents can also be introduced into the risers by injection through atomizing spray nozzles and the like. If for example, steam is employed as a diluent, it can be present in an amount from about 2 to about 8 percent weight based on the hydrocarbon feed charge. Those skilled in the art know that the use of diluents, such as steam, in the riser allows an improvement in feed vaporization, a reduction in hydrocarbon partial pressure and residence time. One interesting side effect is a further reduction in products aromatics content due to lower hydrogen transfer rate thanks to the dilution effect. Therefore for the present invention, the use of diluents, especially in the fresh feed riser, is strongly recommended to help feed vaporization which will be difficult to complete otherwise, due to the low severity operating conditions in regards to the quality of the feed. Moreover, middle distillate production along with its quality will be improved thanks to the dilution effect.

The cracked products and spent catalyst exiting the top of the recycle feed riser (riser reactor R2) are directed via a transition conduit to an external separator device for the separation of cracked products from spent catalyst. This separation device may be of any kind but its design should allow a rapid and efficient separation of the cracked gases from the hot catalyst as such undesired secondary reactions that promote dry gas and coke formation are limited. The spent catalyst is removed from the external rough cut separator via a standpipe and directed into the lower dense phase stripping portion of the stripper vessel, for stripping and subsequent regeneration. The cracked products exiting the top of the rough cut separator may be quenched, recommended in the present invention due to high severity operation in the recycle riser, and then are directed to the upper dilute phase of the stripper reactor vessel for removal of entrained catalyst fines in the cyclones and removed from the stripper reactor vessel for downstream processing.

According to a configuration of the present invention, a manifold can be considered in order to direct the fresh feed either to riser reactor R1, fed with low catalyst activity coming from regenerator RGN1 or riser reactor R2, fed with fully regenerated catalyst from regenerator RGN2. Such a FCCU will present a very high degree of flexibility in terms of operation range as such maxi distillate and maxi conversion/gasoline modes are both achievable depending on economics.

In one embodiment of the invention, the CRC level and the temperature of the catalyst in regenerator RGN1 may also be controlled by recycling the hot fully regenerated catalyst from regenerator RGN2 through the recycle line (i.e., Catalyst Cooler and Recycle Line in FIG. 3) in order to, at the desired proportion, decrease the average CRC (i.e., more active) and increase the regenerator RGN1 temperature. In another embodiment of the invention, a recycle line between regenerator RGN2 and Regenerator RGN1 may also have a catalyst cooler (i.e., Catalyst Cooler and Recycle Line in FIG. 3) to provide operational flexibility for decoupling the control of the average CRC and the average temperature of the catalyst in regenerator RGN1. Provision of catalyst coolers are known to those skilled in the art. In yet another embodiment of the invention, a catalyst cooler can be added in the withdrawal well from regenerator RGN2 to the recycle riser (reactor riser R2) as shown in FIG. 3 (withdrawal well/catalyst cooler, presented in FIG. 3), if it is desired to further increase the C/O ratio in order to improve the selectivity for the desired products. In yet another embodiment, a catalyst cooler can be added in the withdrawal well from regenerator RGN1 (not shown) to the fresh feed of riser reactor R1, if it is desired to further decrease the C/O ratio and at the same time the riser outlet temperature in the fresh feed riser in order to maximize distillate production while maintaining sufficient temperature into regenerator RGN1 to obtain favorable combustion kinetics for the given regenerator RGN1 residence time.

In accordance with the process of the present invention, therefore, the regulation of combustion in the regenerator, and catalyst cooling and recycling can thus be employed to conduct the fresh feed riser reactor profiling for desired product production, for example, in the production of increased yields of light cycle oil/distillate by maintaining desired CRC level, the riser reactor outlet temperatures, and the C/O ratios. Riser reactor profiling can also be conducted as in the manner described herein to maintain desired CRC level, the riser reactor outlet temperatures, and the C/O ratios in the recycle feed riser reactor by increasing the production of light cycle oil/distillate and/or optionally LPG if the objective is to reduce the production of gasoline.

The subject apparatus to carry out the process of the present invention is thus a combination fluid catalytic cracking-regeneration operation comprising at least two elongated riser reactors for catalytically cracking hydrocarbon feeds, e.g., fresh or recycled bottom and/or other less desired products of catalytic cracking, under operating parameters permitting selective conversion to desired products, a single reactor/stripper vessel and a two-stage regenerator system. One of the riser reactor is fitted with a bottom port for receiving partially regenerated catalyst from the bottom of the first regenerator reactor and at least one inlet or injection ports for receiving hydrocarbon feed streams, which include a fresh uncracked hydrocarbon feed. The other riser reactor is fitted with a bottom port for receiving hot fully regenerated catalyst from the second regenerator stage via a withdrawal well, and at least one inlet or injection ports for receiving hydrocarbon feed streams, which include heavy cycle oil, light cracked naphtha, and bottoms recycle of the cracked hydrocarbon feed.

As shown schematically in FIG. 3, one riser, e.g. riser reactor R1, is used to maximize the production of LCO from fresh feed at low severity conditions (low temperature, and low catalyst MAT activity). The second riser, e.g., riser reactor R2, is used to crack the undesirable products (recycled from the main fractionators) at more severe operating conditions (high temperature and high catalyst MAT) to produce light products including gasoline and olefins and limited amount of LCO. Here, the second riser (riser reactor R2) purpose is primarily to “destroy” undesired products coming from the main riser (i.e., riser reactor R1) and/or undesired streams from other units within the refinery. Catalyst may contain ZSM5 additive to enhance lighter hydrocarbon vapor product production in the second riser.

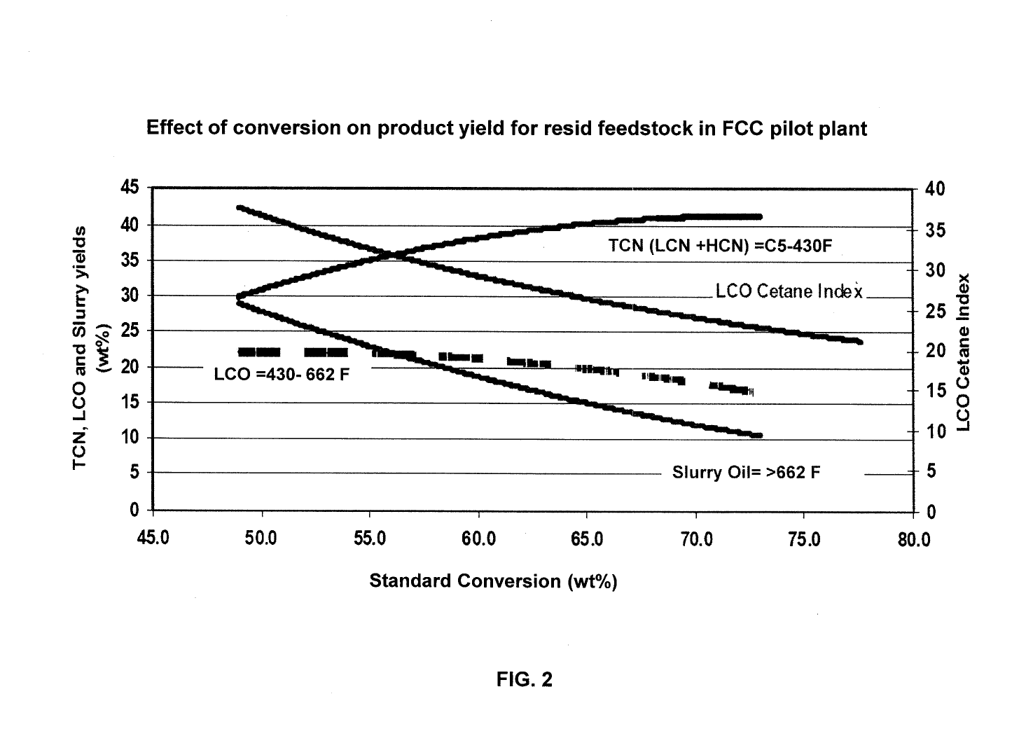

An example of an FCC pilot plant result showing the effect of conversion on LCO, total cracked naphtha (TCN), slurry oil and the LCO cetane index is shown in FIG. 2. Specifically, the effect of cracking severity on LCO, slurry oil and total cracked naphtha (TCN) yield is presented, wherein the LCO (430° F.-660° F.) selectivity in this example plateaus at about 21 wt % at conversion between about 50-60 wt %. Thus, the preferred conversion region is between about 50 and 60 wt %. Maximizing the LCO yield by lowering the conversion/severity also results in the production of a significant amount of slurry oil, while yielding higher quality LCO than if the cracking was done at conversion higher than 60 wt %.

To achieve proper feed vaporization in the present invention, the use of mixed temperature control (MTC) technology is therefore strongly recommended since low cracking severity operation is the key to high quality distillate production.

Regarding catalyst type and composition, any kind of existing and future commercial FCC catalysts and/or additives may be used with the process of the present invention. The addition of catalyst additives may be used to improve bottoms cracking and minimize slurry production.

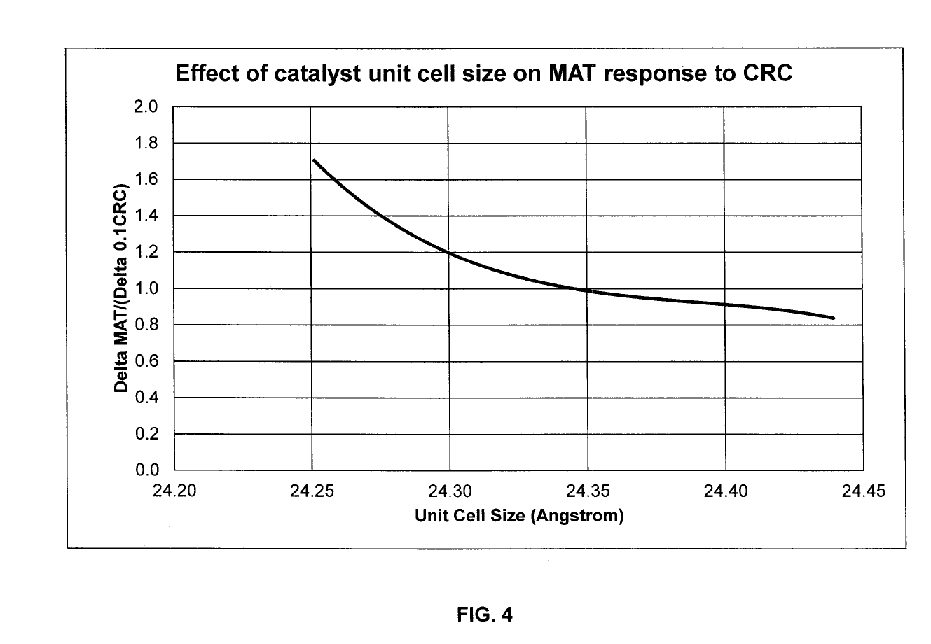

The process of the present invention mostly relies on the effect of CRC on catalyst activity, as presented in FIG. 4. FIG. 4 clearly emphasizes that increasing carbon on regenerated catalyst (CRC) leads to a systematic reduction in catalyst activity or MAT, the extent of which depends on catalyst type, here characterized by its unit cell size. Unit cell size is usually linked to the catalyst zeolite type and content and to the zeolite rare earth type and content, amongst other parameters. The unit cell size is the distance between the repeating cells in the zeolite crystal. The unit cell of typical equilibrium catalyst (catalyst circulating in FCC unit) varies from 24.2 to 24.4. The unit cell size gives a relative indication of active sites hence catalyst activity. For example, for a catalyst with 24.3 Angstrom unit cell size, the catalyst MAT activity will drop by approximately 1.2 wt % for every 0.1 wt % increase in CRC. In other words if the fully regenerated catalyst activity is 60 wt % (0 wt % CRC), its activity will drop to approximately 56.4wt % if the CRC is increased from 0 to 0.3 wt %.

Without wishing to be bound by any theory for the present invention, the catalyst should preferably reduce or minimize hydrogen transfer reactions that may reduce distillate yield and its cetane number. In one embodiment of the invention, the catalyst comprises a large pore zeolite (e.g., synthetic faujasites (X and Y), USY, Y w/ZSM-5 additive; for other examples, numerous references are provided in Catalysis and Zeolites: Fundamentals and Applications by Weitkamp and Puppe (Springer-Verlag, 1999), incorporated herein by reference in its entirety and an active matrix that provides more cracking sites for the large hydrocarbon molecules. The active matrix has both strong and weak acid sites and an optimized pore structure. It is anticipated that the lighter products (such as gasoline, LPG, and gas) are likely produced due to a contact of the hydrocarbon feed with a catalyst that has strong acid sites on the active matrix.

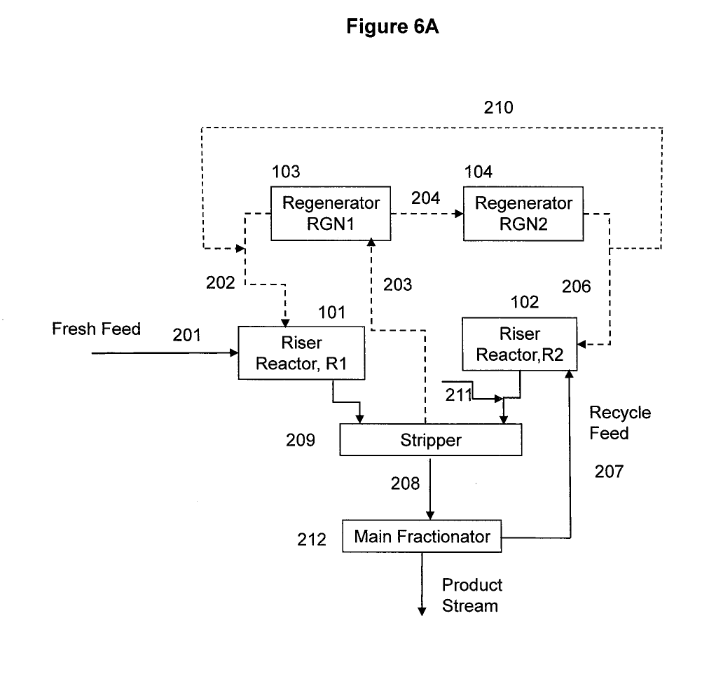

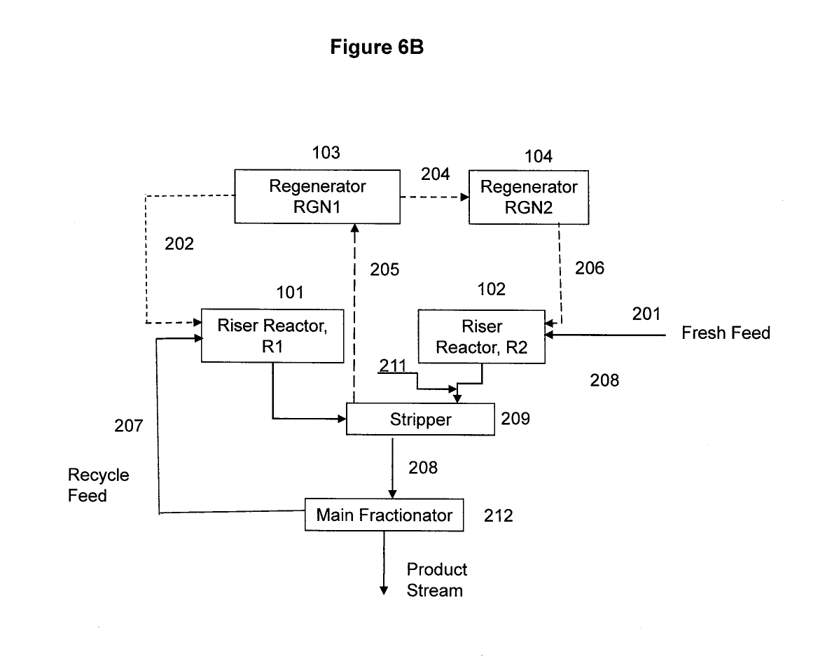

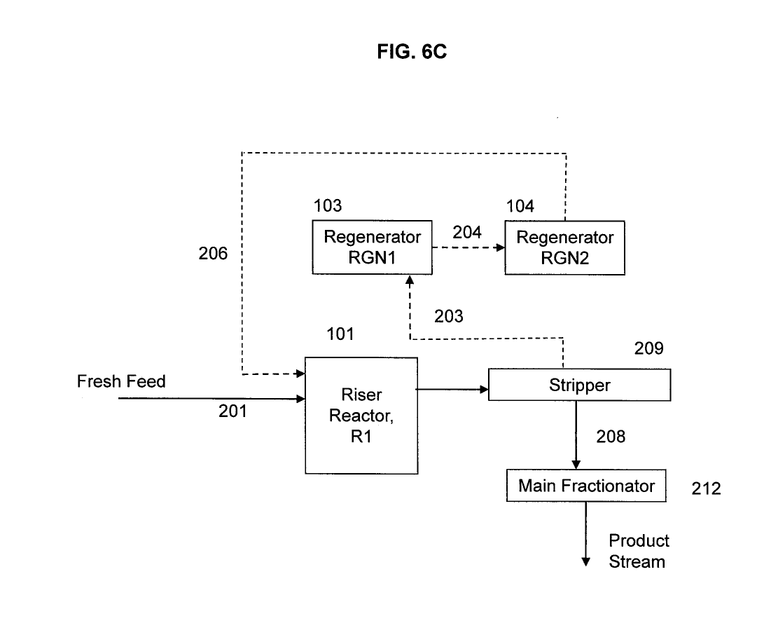

Referring to FIG. 6A, there is shown a flow diagram adapted for performing a specific embodiment of the process of the present invention. Initially, the partially regenerated catalyst with a desired MAT activity is passed from the first stage regenerator RGN1 103 via inlet 202 to riser reactor R1 101. If desired some, some of the fully regenerated catalyst of regenerator RGN2 104 may be routed through conduit 210 to mix with the partially regenerated catalyst for fine control of the catalyst activity entering riser reactor R1 101. Fresh hydrocarbon feed to be catalytically cracked is introduced to a riser reactor R1 101 by conduit means 201. The cracked hydrocarbon product is separated in the stripper 209 and sent to the main fractionator 212 via line 208, while the spent catalyst is returned to the first stage regenerator RGN1 103 for regeneration/processing via line 203. While the partially regenerated catalyst from the regenerator 103 may be again redirected via inlet 202 to a riser reactor R1 101, it also may pass via inlet 204 to the second stage regenerator RGN2 104 to generate fully regenerated catalyst. Subsequently, the fully regenerated catalyst from the second stage regenerator RGN2 104 is passed via line 206 to the bottom of riser reactor R2 102. Concurrently, the uncracked and/or undesired products to be converted to LPG from the main fractionator 212 are passed via line recycle feed 207 to riser reactor R2 102 for further cracking with the fully regenerated catalyst. The spent catalyst of riser reactor R2 102 is combined with the spent catalyst from riser reactor R1 101 in stripper 209, stripped of hydrocarbon vapors and sent to regenerator RGN1 103 via conduit 203 for regeneration. The cracked products are separated from the spent catalyst in an external separator (not shown). The hydrocarbon vapor products are quenched using HCO for example supplied through conduit 211 to lower their temperature prior to entering the stripper 209 where they combine with the hydrocarbon products from riser reactor R1 101.

According to an embodiment of the invention, as in FIG. 6A, riser reactor R1 101 will operate at reduced conversion preferably to maximize the quality and quantity of LCO production. According to this embodiment, the second reactor R2 102, is used to crack recycled streams to make valuable products from un-cracked bottoms from riser reactor R1 101 and/or crack gasoline into LPG if the objective is to minimize gasoline production and maintain at the same time the LPG production at a high level, or downstream units processing C4 olefins for example alkylation or ETBE/MTBE units. Riser reactor R2 102 will operate at a higher riser outlet temperature, C/O and catalyst MAT activity than riser reactor R1 101 to maximize conversion and LPG production. A catalyst cooler (not shown) may be added in the catalyst loop from regenerator RGN2 104 to riser reactor R2 102 if it is desired to further increase the C/O ratio in order to improve the selectivity to the desired products. Another catalyst cooler (not shown) may also be used to cool the catalyst from regenerator RGN1 103 to riser reactor R1 101 to further increase C/O and riser outlet temperature to maximize LCO production while maintaining sufficient temperature in regenerator RGN1 103 for regeneration.

Referring now to FIG. 6B, there is shown a flow diagram where the feeds are switched. Initially, the fully regenerated catalyst from the regenerator RGN2 104 is passed via line 206 to the bottom of the riser reactor R2 102. Subsequently, the fresh hydrocarbon feed to be catalytically cracked is introduced to riser reactor R2 102 by conduit means fresh feed 201. The cracked products from riser reactor R2 102 is separated in stripper 209, while the spent catalyst is returned to the regenerator RGN1 103 for regeneration/processing via line 205. The uncracked and/or undesired products (also HCO and/or decant oil) from the main fractionator 212 are passed via line 207 to riser reactor R1 101 for further cracking with the partially regenerated catalyst that is passed from the first stage regenerator RGN1 103 via inlet 202 to riser reactor R1 101. While the partially regenerated catalyst from the regenerator RGN1 103 may be again redirected via inlet 202 to riser reactor R1 103, it also may pass via inlet 204 to the second stage regenerator RGN2 104 to generate fully regenerated catalyst. The cracked desired product is separated from the riser reactor R1 101 and combined with hydrocarbon products from riser reactor R2 102 in the stripper 209 prior to being routed to the main fractionators 212 via line 208 where the products are separated. The spent catalyst from riser reactor R1 101 and riser reactor R2 102 are combined and stripped of entrained hydrocarbons in the stripper 209 before being sent for regeneration through line 205 into regenerator RGN1 103. The alternative embodiment of switching of the feeds between the fresh feed 201 riser reactor R1 101 and riser reactor R2 102, may be used to increase or maximize the gasoline production.

In yet another alternative embodiment to that described above, the process and apparatus of the present invention also affords, if desirable to do so, complete shutdown of the recycle feed processing by closing the slide valve and maintaining a steam purge. Thereby, the FCC unit reverts to a standard two-staged regenerator FCC operating mode with a single riser reactor. In order to keep the full capacity of the FCC, a connection between the fully regenerated catalyst withdrawal well outlet and the fresh feed riser reactor can be added in order to route regenerated catalyst into the main fresh feed riser reactor.

Referring now to FIG. 6C, there is shown a flow diagram where riser reactor R2 102, i.e., the recycle riser is turned off (not shown in FIG. 6C), as such, utilizing the system as a standard FCC configuration. Initially, the fully regenerated catalyst from the regenerator RGN2 104 is passed via line 206 to the bottom of riser reactor R1 101. Subsequently, the fresh hydrocarbon feed to be catalytically cracked is introduced to riser reactor R1 101 by conduit means fresh feed 201. The cracked products are separated from riser reactor R1 101 in stripper 209 and the spent catalyst is returned to the regenerator RGN1 103 for regeneration/processing via line 203. The hydrocarbon products are sent to the main fractionators 212 for further processing via conduit 208.

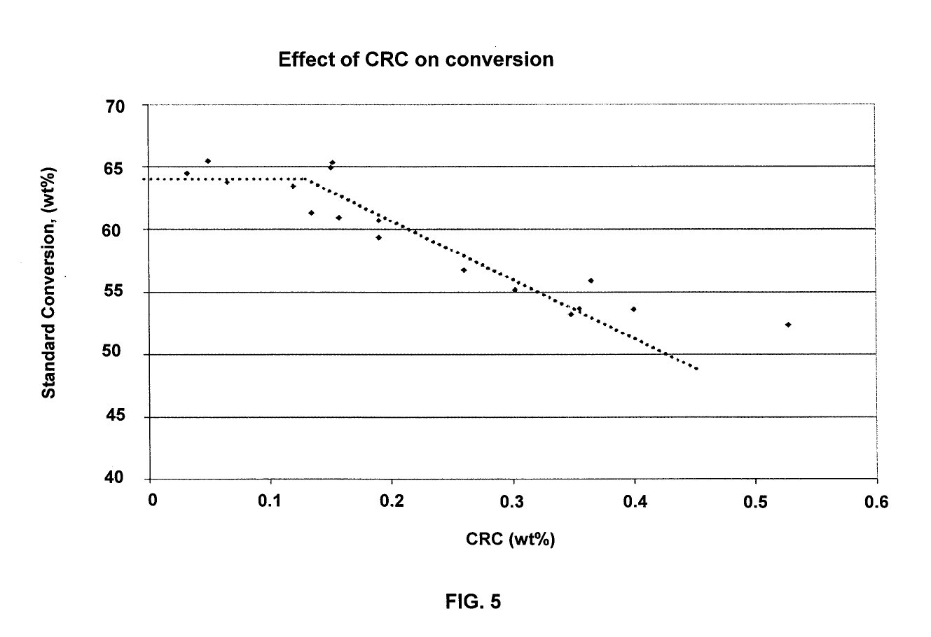

As already discussed hereinabove, the conversion of fresh feed 201 in the riser reactor R1 is regulated/controlled by modifying the reactor temperature, C/O ratio and catalyst activity (via CRC level) to achieve maximum distillate yield while minimizing dry gas, coke and slurry. The pilot plant employing the process of the present invention has been examined. The results are presented in FIG. 2 show the effect of conversion on LCO, total cracked naphtha (TCN), slurry and the LCO cetane index. In order to operate the FCCU in a fresh feed conversion region that maximizes distillate production and its cetane index, while minimizing the slurry oil yield, the conversion of fresh feed should be preferably maintained between about 50 and about 60 weight percent and can vary depending on the feed quality. The conversion of fresh feed, which maximizes distillate production is performed by changing the CRC in addition to operating parameters, such as, riser outlet temperature. The sensitivity of fresh feed conversion to CRC is shown for example in FIG. 5. For this example, the conversion region of interest corresponds to a CRC preferably comprised between about 0.2 to about 0.5 weight percent and the catalyst MAT activity in the range of about 50 wt % to about 67 wt %. Conversion in the reactor riser, e.g., R1 will be changed by modifying reactor temperature, C/O (catalyst to oil ratio) and catalyst surface area or activity to achieve maximum middle distillate yield while minimizing dry gas, coke and slurry oil. A mixed temperature control technology may be used to aid in feed vaporization in the reactor riser, e.g., R1.

It will be appreciated by persons skilled in the art that the present invention is not limited to what has been particularly shown and described hereinabove. Rather, the scope of the present invention is defined by the claims which follow. It should further be understood that the above description is only representative of illustrative examples of embodiments. For the reader's convenience, the above description has focused on a representative sample of possible embodiments, a sample that teaches the principles of the present invention. Other embodiments may result from a different combination of portions of different embodiments.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are hereby incorporated by reference as if fully set forth in this specification.

What is claimed is:

1. A method for increasing middle distillate production and quality from a hydrocarbon feed, said method comprises:
a) delivering a partially-regenerated catalyst to a first riser reactor, and a fully-regenerated catalyst to a second riser reactor and optionally to said first reactor;
b) cracking the first feed chosen between a hydrocarbon feed and a recycle feed comprising at least uncracked bottoms in the first riser reactor to produce a first cracked product and spent catalyst;
c) separating said first cracked product including a middle distillate from said spent catalyst in a single reactor vessel;
d) recovering said first cracked product including said middle distillate and separating uncracked bottoms from said first cracked product;
e) cracking the second feed chosen between the recycle feed or the hydrocarbon feed, but different from the first feed, in the second riser reactor to produce a second cracked product;
f) separating the second cracked product including a middle distillate from spent catalyst in said single reactor vessel; and
g) passing the spent catalyst from the first and second riser reactors to a multi-stage catalyst regenerator unit,
wherein said multi-stage catalyst regeneration unit provides said partially-regenerated catalyst and said fully-regenerated catalyst having different MAT activity for use in said first and/or said second riser reactors.

2. The method of claim 1 wherein the multi-stage catalyst regenerator unit is a single two-stage catalyst regenerator unit and the spent catalyst is partially regenerated in a first regeneration stage of said two-stage catalyst regenerator, a first portion of said partially-regenerated catalyst is delivered to the first riser reactor; a second portion of said partially-regenerated catalyst is delivered to a second regeneration stage of said two-stage catalyst regenerator, to produce fully regenerated catalyst, and said fully-regenerated catalyst is delivered to said second riser reactor and, optionally, to said first riser reactor.

3. The method of claim 1 wherein said partially-regenerated catalyst has a MAT activity that is less than the MAT activity of the fully regenerated catalyst.

4. The method of claim 1 wherein said partially-regenerated catalyst has a MAT activity from about 30 weight percent to about 65 weight percent.

5. The method of claim 1 wherein said fully-regenerated catalyst has a MAT activity from about 50 weight percent to about 80 weight percent.

6. The method of claim 1 wherein the partially-regenerated catalyst has a carbon on regenerated catalyst (CRC) of about 0.2 to about 0.5 weight percent.

7. The method of claim 6 wherein the partially-regenerated catalyst has a carbon on regenerated catalyst (CRC) of about 0.3 to about 0.4 weight percent.

8. The method of claim 1 wherein the hydrocarbon feed is selected from the group consisting of vacuum gas oils, heavy atmospheric gas oil, atmospheric resid, vacuum resid, coker gas oils, visbreaker gas oils, deashalted oils, hydrocracker bottoms, vegetable oils and heavy conversion product issued from biomass, and any combination thereof or hydrotreated counterparts.

9. The method of claim 1 wherein the hydrocarbon feed is injected into the first riser reactor and the recycle feed is injected into the second riser reactor.

10. The method of claim 1 wherein the hydrocarbon feed is injected into the second riser reactor and the recycle feed is injected into the first riser reactor.

11. The method of claim 1 wherein the cracked product of the first and second riser reactor comprises one or more gaseous product streams comprising C₃ through C₆ light olefins, C₆-C₈ light FCC gasoline, light cracked naphtha (LCN), intermediate FCC gasoline comprising benzene and C₈-C₉ hydrocarbons, heavy FCC gasoline comprising C₉-C₁₁ hydrocarbons and other gasoline boiling range products comprising materials boiling in the range C₅ to about 430° F., middle distillate boiling in the range from about 330° F. to about 630° F., and uncracked bottoms boiling range from about 650° F. to about 900° F.

12. The method of claim 11 wherein the uncracked bottoms comprises at least one of the hydrocarbon cuts among the group comprising heavy cycle oil product (HCO) boiling from about 650° F. to about 900° F., and slurry oil boiling from about 467° F. to about 970° F. and above.

13. The method of claim 1 wherein the recycle feed contains at least one product from the group consisting of light FCC gasoline (LCN), heavy cycle oil product (HCO) and slurry oil.

14. The method of claim 1 wherein the first riser reactor operates with an outlet temperature of from 850° F. to about 950° F.

15. The method of claim 1 wherein the second riser reactor operates with an outlet temperature of from 970° F. to about 1150° F.

16. The method of claim 1 wherein the catalyst-to-oil (C/O) ratio of said first riser reactor is less than the catalyst-to-oil ration of the second riser reactor.

17. The method of claim 16 wherein the catalyst-to-oil (C/O) ratio of said first riser reactor is less than the catalyst-to-oil ration of the second riser reactor by about 0.1 wt/wt to about 4 wt/wt.

18. The method of claim 10 wherein the catalyst-to-oil (C/O) ratio of said first riser reactor is greater than the catalyst-to-oil ration of the second riser reactor by about 2 wt/wt to about 10 wt/wt.

19. The method of claim 1 wherein said spent catalyst is stripped before regeneration.

20. The method of claim 1 wherein said cracked products from said second riser reactor are quenched.

21. A hydrocarbon cracking system for maximizing middle distillate production comprising, a multistage-stage catalyst regeneration unit that provides partially-regenerated catalyst and/or fully-regenerated catalyst respectively to a first riser reactor and a second riser reactor, each receiving a different feed chosen between hydrocarbon feed and recycle feed, and a single reactor vessel to send coked catalyst to said regeneration unit, wherein the catalyst of said system has a different MAT activity in said partially-regenerated catalyst and said fully regenerated catalyst.

22. The system of claim 21 wherein said multi-stage catalyst regenerator unit is a single two-stage catalyst regeneration unit comprising a first regeneration stage and a second regeneration stage and wherein the catalyst is a partially-regenerated catalyst at the exit of the first regeneration stage and a fully-regenerated catalyst at the exit of the second regeneration stage.

23. The system of claim 22 wherein the catalyst of the second regeneration stage is mixed with catalyst in the first regeneration stage.

24. The system of claim 22 wherein the catalyst in the first regeneration stage has a MAT activity that is less than the MAT activity of the catalyst of the second regeneration stage.

25. The system of claim 22 wherein the catalyst in the first regeneration stage has a carbon on regenerated catalyst (CRC) of about 0.2 weight percent to about 0.6 weight percent.

26. The system of claim 22 wherein the catalyst in the first regeneration stage has a carbon on regenerated catalyst (CRC) of about 0.3 weight percent to about 0.4 weight percent.

27. The system of claim 21 wherein the hydrocarbon feed is selected from the group consisting of vacuum gas oils, heavy atmospheric gas oil, atmospheric resid, vacuum resid, coker gas oils, visbreaker gas oils, deashalted oils, hydrocracker bottoms, vegetable oils and heavy products from the biomass conversion, and any combination thereof or hydrotreated counterparts.

28. The system of claim 21 wherein the cracked product from the first and second riser reactors comprises one or more gaseous product streams comprising C₃ through C₆ light olefins, C₆-C₈ light FCC gasoline(LCN), intermediate FCC gasoline comprising benzene and C₈-C₉ hydrocarbons, heavy FCC gasoline comprising C₉-C₁₁ hydrocarbons and other gasoline boiling range products comprising materials boiling in the range C₅ to about 430° F., middle distillate boiling in the range from about 330° F. to about 650° F., and uncracked bottoms boiling range from 650° F. to about 900° F. and above.

29. The system of claim 21 wherein the uncracked bottoms comprise at least one of the hydrocarbon cuts among the group comprising heavy cycle oil product (HCO) boiling from about 650° F. to about 900° F., and slurry oil boiling from either about 670° F. to about 970° F. and above.

29. The system of claim 21 wherein the recycle feed contains at least one product from the group consisting of light FCC gasoline (LCN), heavy cycle oil product (HCO) and slurry.

30. The system of claim 21 wherein the first riser reactors operate with an outlet temperature of from about 850° F. to about 950° F.

31. The system of claim 21 wherein the second riser reactor operates with an outlet temperature of from about 970° F. to about 1150° F.

32. The system of claim 21 wherein the first regenerator operates with an outlet temperature of from about 1150° F. to about 1300° F.

33. The system of claim 21 wherein the second regenerator operates with an outlet temperature of from about 1300° F. to about 1400° F.

34. The system of claim 21 wherein the partially-regenerated catalyst has a MAT activity form about 30 weight percent to about 65 weight percent.

35. The system of claim 21 wherein the fully-regenerated catalyst has a MAT activity from about 50 weight percent to about 80 weight percent.

36. The system of claim 21 wherein the catalyst-to-oil (C/O) ratio of said first riser reactor is less than the catalyst-to-oil ratio of the second riser reactor.

37. The system of claim 36 wherein the catalyst-to-oil (C/O) ratio of said first riser reactor is less than the catalyst-to-oil ration of the second riser reactor by about 2 wt/wt to about 4 wt/wt.

38. The system of claim 36 wherein the catalyst-to-oil (C/O) ratio of said first riser reactor is less than the catalyst-to-oil ration of the second riser reactor by at least about 1 wt/wt.

39. The system of claim 21 wherein the catalyst is at least one selected from the group consisting of silica, alumina, large pore zeolites such as those with a faujasite structure, silica-alumina, zirconium, magnesium, intermediate pore size zeolites such as those with pentasil structure and combinations of some or all of said materials.

40. The catalyst in claim 39 may contain additives such as ZSM5 and/or bottom conversion additives depending on yield objectives.
